(19) United States
(12) Patent Application Publication
(10) Pub. No.: US 2013/0175352 A1
(43) Pub. Date: Jul. 11, 2013

(54) METHOD TO INFLUENCE THE DIRECTION OF TRAVEL OF HURRICANES

(71) Applicant: Edwin Allen BURNS, Loxahatchee, FL (US)

(72) Inventor: Edwin Allen BURNS, Loxahatchee, FL (US)

(21) Appl. No.: 13/345,703

(22) Filed: Jan. 7, 2012

(51) Int. Cl. A01G 15/00

(52) U.S. Cl. 239/2.1

(57) ABSTRACT

In like manner that winds intersect and deflect each other in space we can intersect and deflect the hurricanes and storms at the area of thrusting between their steering winds and their outer edge, with blasting explosion waves of non-nuclear high-power propellant fuel missiles thrown in vertical perpendicular alignment, against the routing of the steering wind current at N equal number of levels, first for testing a 300 pounds missile thrown, by adequately equipped air-vehicles for missiles launching, to observe the effect on the hurricane configuration, then decide to adjust the explosive quantity to thrust successfully, all blasts of each round of missiles should be detonated in a timely manner, then continue the rounds of explosives at intervals approximately similar to the time required by the prior blast to travel twice the diameter of its explosion, repeating as necessary, hitting always at the thrusting area until achieving success.

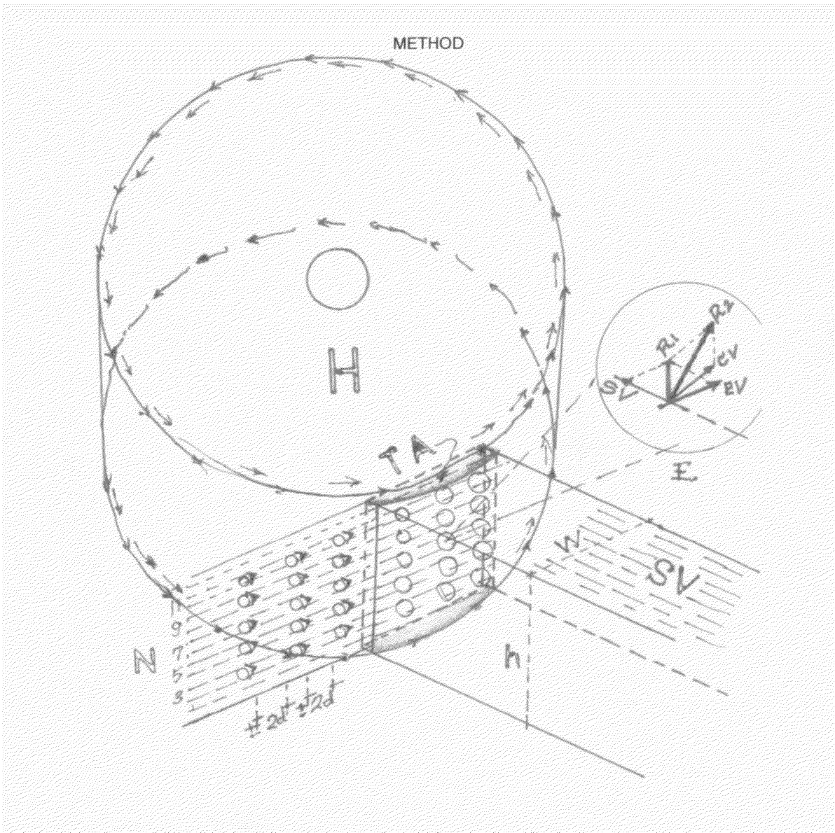

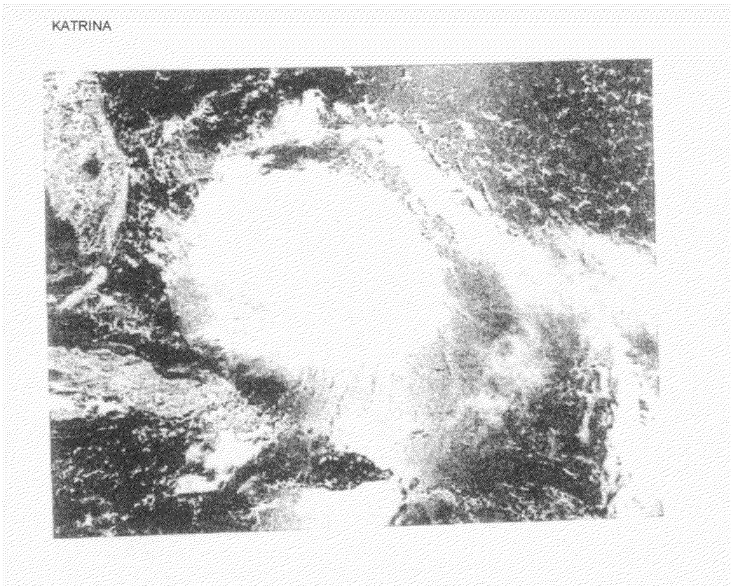

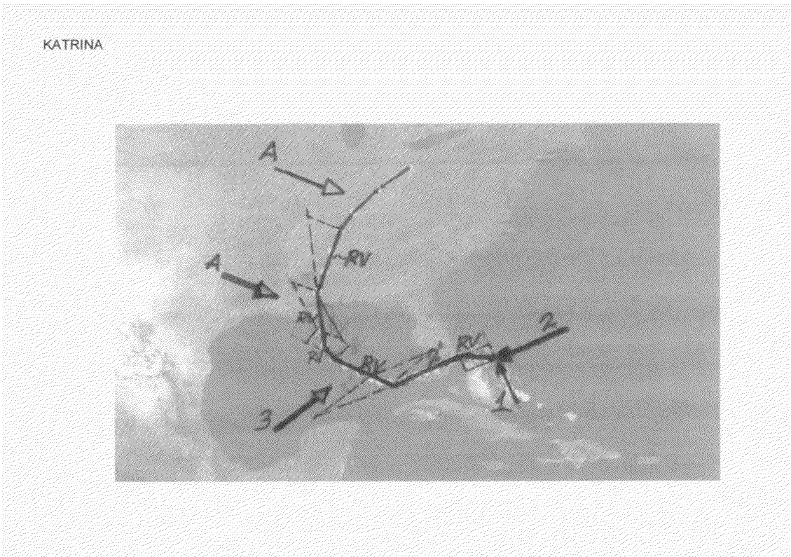

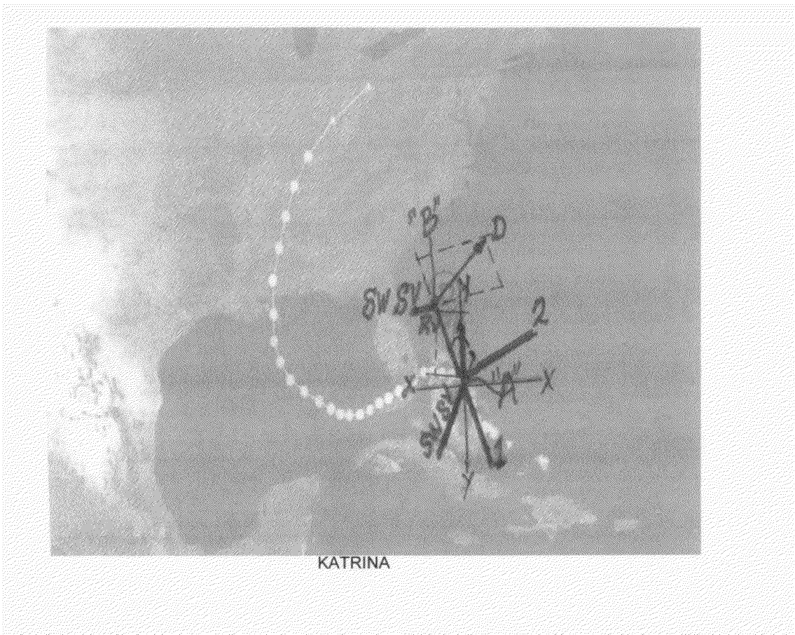

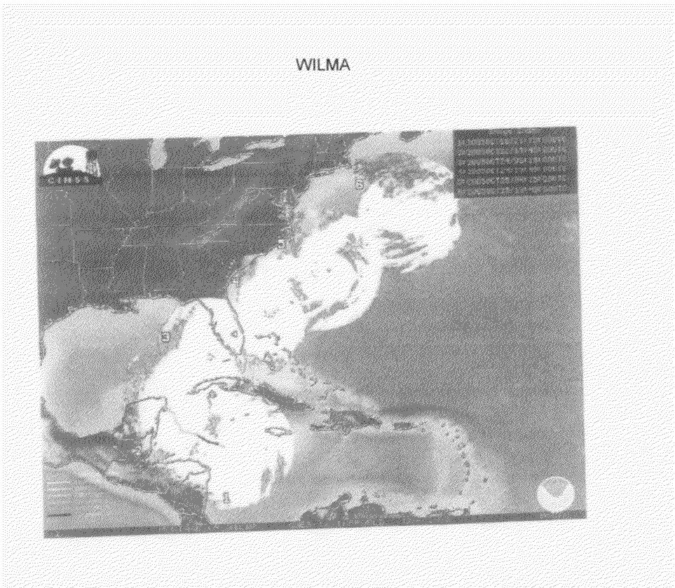

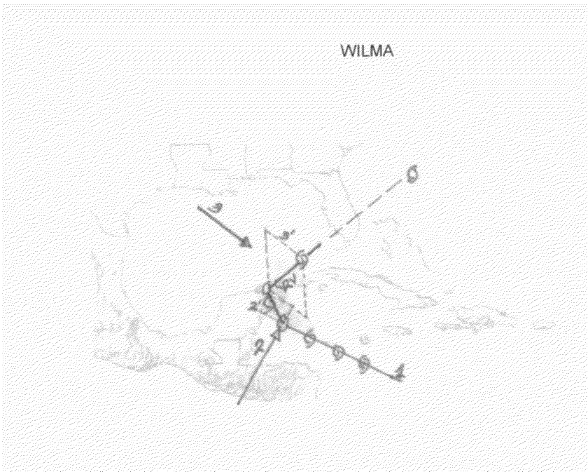

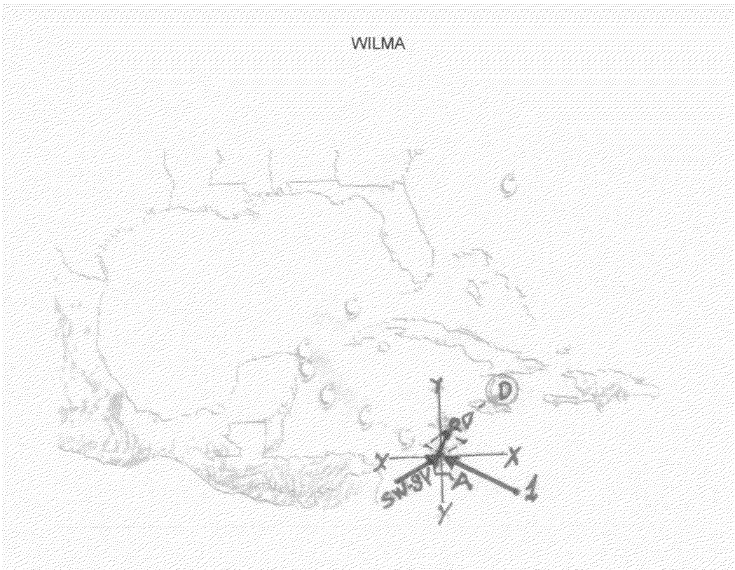

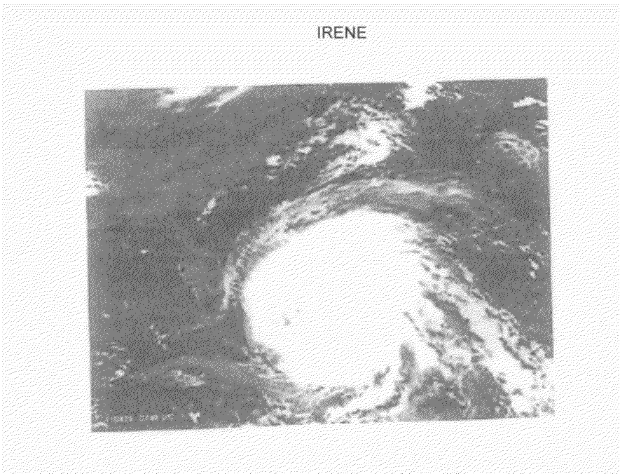

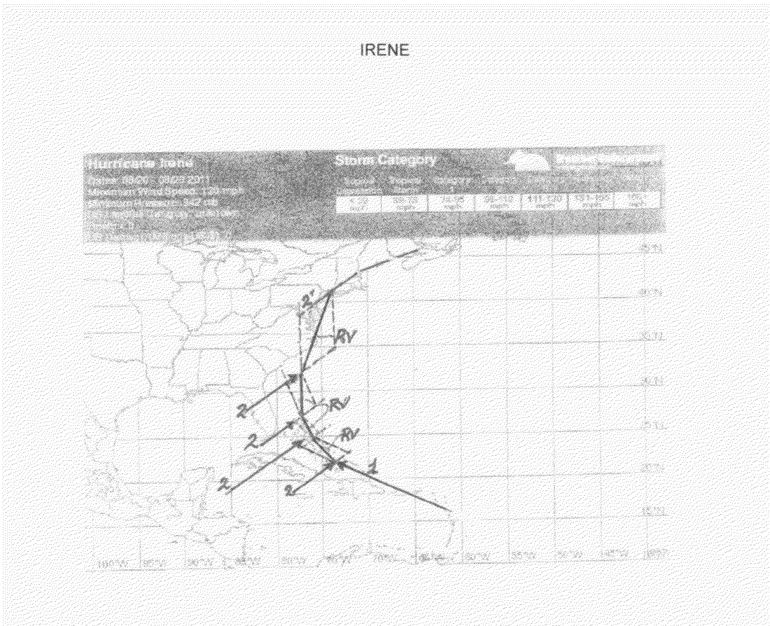

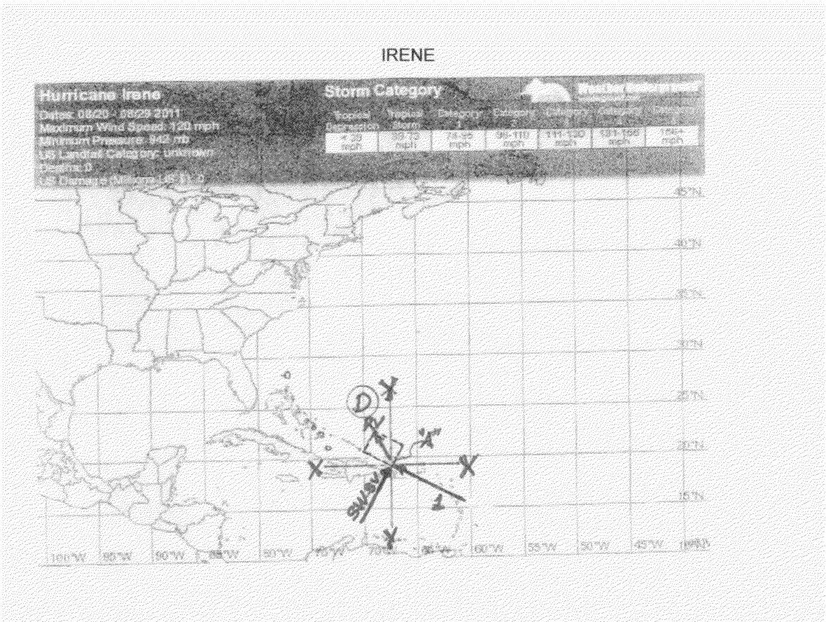

### STATEMENT REGARDING FEDERALLY SPONSORED RESEARCH OR DEVELOPMENT

This Method to be implemented requires the full support and sponsorship of the United States Federal Government to conduct research, under controlled Laboratory Conditions, to the proper size scale, and live field testing, for the following:

E-1) Testing of the wind currents interaction as vector forces and their compliance with the mathematical rules of vectors.

E-2) Testing of selected propulsion wave forming explosives impacting on wind currents.

E-3) Testing of selected propulsion wave forming explosives impacting on large balloons suspended inside wind currents.

E-4) Conduct research on selected explosives to find the best fitted compliance with the requirements of the Inventor, as follows:

E-4-a) Find the explosives that shall push more effectively on the spinning mass of winds and water vapor.

E-4-b) Find the properties of the explosives: 1) Density of the expansive gases. 2) Heat generated by the explosions. 3) Also their combined effect with different types of detonating explosives. 4) Thrusting power. 5) Storable safety. 6) Cost.

E-4-c) Find the best fitted missiles to deliver the swaying vectors as well as any other better way to accomplish the objective. Find the safest distance to launch the missiles or explosives as well as the safest minimum height to launch them and the best-fitted air-vehicles to use, or other better ways, in lived field testing.

E-5) It is anticipated that density of the expansive gases selected to push on the steering wind current and the spiraling winds of the hurricane should be no greater than air, because air pushes on the storm, due to the combined density of water vapor and air of the storm, being greater than air.

### CROSS-REFERENCE TO RELATED APPLICATIONS

Cross-Reference No. 1: “PHYSICS De MYSTIFIED BY MR. STAN GIBILISCO”: Mathematics of Vectors for two and for three dimensions.

### INCORPORATION-BY-REFERENCE OF MATERIAL, SUBMITTED ON A COMPACT DISC

Not Applicable.

### BACKGROUND OF THE INVENTION

1. Field of the Invention

Engineering, Meteorology, Mechanical, Mathematical Rules of Vectors, Explosives and Military Equipment Expertise:

The background is mainly Mechanical Engineering because hurricanes are thermodynamic systems from the moment they are born to the moment they get extinguished. They absorb energy in the form of heat and water vapor by way of its center opening called eye. Rotate absorbing energy and water vapor and storage it by revolving. Grow in size by increasing its speed. The system keeps its mass in place by the combined action of the centrifugal and centripetal forces that also causes the typical spiraling doughnut form. Dispose of the excess energy thru the perimeter, outer edge of the system, in the form of rain and gusts. The rotating vectors of the storm, allows it to be pushed by the steering wind vectors action and reaction forces. The thermodynamic roll is present at all times from birth to extinguishment. The thermodynamics is trying to reach equilibrium in a state of storm due to a process of transfer of energy that is inherently a non-equilibrium process.

The Meteorology background is related with the barometric pressure differences that cause wind currents and regulate their movements. Meteorology is indispensable in the initial conditions for the birth and growth of storms, to become hurricanes and to keep them working.

The math of vectors works, all the time when thrusting on the back of the storms and at the time of interception, with other currents, as clearly shown in the photographs 2 thru 10 of the section of Drawings and Photographs of this application.

Knowledge on explosives and military equipment expertise is required as part of the Federal Sponsorship for research and development. At this stage, of my application, my guesses are based on what information is available in the Internet and my own judgment.

Hurricanes are formed usually over the ocean at hot areas where there is great activity of heat and mass transfer (see Ref. #2). Also, the atmospheric barometric conditions favor the formation of winds that together, with the excessive heat and mass transfer, creates a turbulence that accidentally succeeds in getting organized, starts rotating, grow and accumulates energy in becoming a thermodynamic system. When the hurricane is steered to new areas the energy transfer conditions are favorable and the storm grows, increasing the storage area by way of increasing the rotating speed. The centrifugal and centripetal forces also grow proportionally to the increment of rotational speed. Hurricanes do not have forward motion of its own, thanks GOD. The storms depend on the thrusting of a steering wind to move.

By swaying Hurricanes away from their steering winds and usual routes we will save many lives and billions of dollars, to the Country. Also, by thrusting against the outer edge of the Hurricane, with moderate quantities of expansive explosive waves we can push the storms towards calm areas. There in the calm area, the storm may dissipate its energy in due time and the thermodynamic of the system will win its struggle and cease.

2) Description of Related Art Including Information Disclosed Under: 37 CFR 1.97 and 1.98: Excerpt Re: 37 CFR 1.98

I did not found applicable information from 1.97: “Filing of information disclosure” and 1.98: “Content of information disclosure” from the Consolidated Patent Rules, at this time.

### BRIEF SUMMARY OF THE INVENTION

MY METHOD SHALL INFLUENCE THE DIRECTION OF TRAVEL OF HURRICANES AND STORMS BY WAY OF CUMULATIVE BLASTING EXPLOSIONS. WE SHALL USE NON-NUCLEAR SOLID OR STORABLE LIQUID PROPELLANT FUEL THAT SHALL PRODUCE HIGH-TRUST EXPANSIVE WAVES OF HOT GASES. THESE GASES SHALL BE OF LESSER DENSITY OR EQUAL TO AIR. THE EXPLOSIVE WAVES MUST BE OF ADEQUATE SPEED AND THRUST POWER TO EFFECTIVELY PUSH ON WIND CURRENTS AND ON THE ROTATING WINDS OF HURRICANES. THE EXPLOSIVES SHALL BE ENCAPSULATED INSIDE MISSILES LAUNCHED FROM ADEQUATELY EQUIPPED AIR VEHICLES. ALL IMPACTS MUST BE ON ONE SIDE SECTION OF THE OUTER EDGE PERIPHERY AND OR INSIDE SPINNING WINDS OF THE STORMS. SUCCESS DEPENDS ON STRIKING ALWAYS INSIDE THE THRUSTING AREA BETWEEN THE STEERING WIND AND THE OUTER EDGE OF THE HURRICANE. A THREE HUNDRED POUNDS MISSILE OF PROPELLANT FUEL, AS MENTIONED ABOVE, SHALL BE TRIED FIRST ALONE FOR TESTING, IF NOT RECOMMENDED OTHERWISE BY THE TESTING LABORATORY. OBSERVE THE EFFECTS ON THE HURRICANE CONFIGURATION. THEN DECIDE IF IT IS ADEQUATE AS LAUNCHED OR IF IT IS REQUIRED TO ADJUST THE QUANTITY OF EXPLOSIVE OR ITS POWER. IF THE EXPLOSIVE BLAST IS TOO FAST OR TOO STRONG IT WILL PUNCH A HOLE INSTEAD OF PROVIDING US WITH THE THRUSTING POWER THAT WE SEEK. THE EXPLOSIONS SHALL BE TIMED AND ALIGNED IN THE SELECTED ROUTING TO ACCUMULATE THE FORCES IN ONE DIRECTION, AS VECTORS DO. THE MISSILES SHOULD BE THROWN IN VERTICAL FORMATION PERPENDICULAR TO THE ROUTING OF THE STEERING WIND. THE TOTAL HEIGHT OF THE STEERING WIND SHOULD BE DIVIDED BY NO MORE THAN TWICE THE LENGTH OF THE DIAMETER OF THE EXPLOSION, TO FIND THE NUMBER OF LEVELS OF ACTION. ALL LEVELS OF ACTION SHOULD BE LOADED AT THE SAME TIME AND DETONATED SIMULTANEOUSLY OR IN A SEQUENCE OR OTHERWISE, AS PLANNED. THE GENERATED VECTOR FORCES OF THE EXPLOSIONS SHALL INTERCEPT THE STEERING WIND CURRENT AND COMBINE WITH IT. ALSO COMBINE WITH THE COUNTERCLOCKWISE VECTORS OF THE OUTER EDGE OF THE HURRICANE. THE COMBINED FORCE OF THESE THREE VECTORS THUS FORMED SHALL BE FOLLOWED ALMOST IMMEDIATELY BY EQUAL RESULTANT VECTORS OF THE FOLLOWING EXPLOSIONS. THAT ACTION SHALL BUILD-UP TO START SWAYING THE HURRICANE. UNTIL, FINALLY SUCCEED IN REACHING THE OTHER SIDE OF THE STEERING WIND RANGE. THE HURRICANE SHALL CONTINUE BY INERTIA FURTHER AWAY.

### BRIEF DESCRIPTION OF THE SEVERAL VIEWS OF THE DRAWINGS

The Method is all, in one page only, of typical drawing (See page 1 of 10). The other nine photographic pictures are to illustrate how each steering wind complied with the vector rules of Descartes and steered, in turn, behind the rotating winds in its own direction. (See pages 2 thru 10)

### (Method Drawing, Specification):

This is a typical drawing that illustrate the method to influence the direction of travel of hurricanes, as follows: (See 1 of 10) this is, a not to scale drawing that shows a three dimensional representation of a Hurricane called ‘H’ and its steering wind called ‘St. W’., its range width and its height called ‘h’. Also, showing the thrusting area called ‘Th. A’., with ‘N” being the number of levels of action found by dividing the height of the steering wind by two times the diameter of the typical explosion called ‘2d’, hence N=h/2d. The drawing 1 of 10 shows three missiles only (for clarity of drawing, only.) the missiles are indicated by the symbol: O>O>O> shown at each level of action at the instant just before entering into the Thrusting Area. The intention is to have it spaced twice the typical explosion diameter before exploding inside the Thrusting Area. Also, the drawing shows the instant when prior missiles are exploding inside the thrusting area indicated by the symbol of: ∘ ◯ O precisely at the moment of combining with the vectors of the steering wind and the counterclockwise vectors of the outer edge of the hurricane (see enlarged detail in 1 of 10). The resultant vector of one explosion will add-up to with the resultant vectors of the immediately following explosions and keep-on moving the hurricane towards the outer edge of the range of the steering wind, (see the drawing detail enlargement showing the interception and combination of the three vectors in space). The Method will succeed when finally the hurricane have been moved completely out of the range of the steering wind.

Method Nomenclature:

H=Hurricane

SW=Steering wind

TA=Thrusting Area

E=Enlargement Detail

N=Number of Levels of Action

NTS=Not to Scale

w=Width of Wind Current

h=Height of Wind Current

d=Diameter of Missile explosion

SV=Steering Wind Vectors

EV=Explosion Vectors

CV=Counterclockwise Vectors

R1=Resultant of SV and EV

R2=Resultant of R1 and Counterclockwise Vectors

### (Amended Drawings, Photographs of Hurricanes Katrina, Wilma and Irene, See the Corresponding Markings in Prior Revised Clean Versions)

The following nine photographs (pages 2 thru 10) are for the purpose to illustrate how the steering winds intercept and produce a resultant vectors that steer the hurricane in a different direction as they did for hurricanes Katrina, Wilma and Irene. Every new turn in direction correspond exactly to the rules of Descartes. Also, it shows the pivotal point and last chance for using my method to sway the hurricane in a different direction that could have been used, presented, as follows:

A-1) Case 1: Hurricane Katrina, as it happened, in year 2005. Katrina's photograph shown in page 2 of 10 shows the hurricane poised over the Bahamas, east of Florida and north east of Guantanamo. At this time Vector 2 a powerful Atlantic Ocean wind current traveling in a south-western direction intercepts Vector 1 that was the steering wind carrying hurricane Katrina in a north-western direction up to that point. See in page 3 of 10 how Vector 2 prevailed and established Resultant Vector 2″ with a south-western routing. Vector 3 a powerful Pacific Ocean wind current traveling with a northeastern direction confronted Vector 2″, over the Gulf of Mexico, prevailed establishing a new resultant with a north-western routing. Vector A, the #4 vector, prevailing North America wind, traveling in a south-eastern direction confronted the resultant vector of 3 and 2″ deflecting the routing of hurricane Katrina directly into the City of New Orleans. The wide and powerful North America's vector A, # 4, continued deflecting the resultant vectors and established a new over land north-eastern routing of the storm, until final extinguishment.

On page 4 of 10 we have a situation we wish never have: a complete developed hurricane that will require our full blasting capacity and maximum coordination at the pivotal point A over the Bahamas intercepting the steering wind 1 with our swaying vectors SW SV. We will intercept almost immediately the powerful Atlantic wind 2 to do our very best to prevail. If we succeed to push the Hurricane over the ocean in front of Daytona Beach, Saint Agustin area at B, second point of action for our swaying vectors. Then we still need to push the hurricane with some more missiles at its back to finally reach the destination area D. Any calm waters wherever available.

In real life, if allowed the privilege to use my method I would rather have chosen an earlier location of the trajectory of the storm on the eastern side of the Virgin Islands where I would have selected a destination area in the general direction of the known calm waters, but NOT inside or close to the Vessels Museum of Nature, the famous Sargasso Sea area, far enough to avoid disturbing it, and to let the storm dissipate its energy.

B-1) Case 2: Hurricane Wilma, as it happened in year 2005. The photograph called Hurricane Wilma page 5 of 10 shows the critical pivotal point where Vector 2, a wide Pacific Ocean wind current, traveling in a north-eastern direction, intercepts and deflects Vector 1, which was the steering wind that was carrying hurricane Wilma, see page 6 of 10, establishing a resultant vector with a north-western course. The continued intercepting and swaying Vector 2, acted upon the new resultant vector and deflected near Cancun the routing of hurricane Wilma towards the north. Vector 3 the prevailing wind from North America intercepted the new resultant vector of 2 and 1 in the middle of the Gulf of Mexico to send it directly to hit Florida with an Eastern routing.

B-2) Case 2: Hurricane Wilma, as it could have been swayed away in year 2005. Hurricane Wilma, shown in page 6 of 10, could have been swayed away at an earlier point of the trajectory of Vector 1, the steering wind that was carrying hurricane Wilma. In the case shown in the picture our best option was to apply our swaying vectors at the south-western side of the hurricane at point A to push the hurricane towards a destination area located on the north-eastern side of Jamaica Island to leave it there, stagnant, to consume its energy or further move it to the north-eastern side away from Guantanamo Bay.

C-1) Case 3: Hurricane Irene, as it happened in year 2011: Page 8 of 10 of the photographs shows hurricane Irene carried by Vector 1 the steering wind that was carrying hurricane Irene was traveling north of Puerto Rico and Dominican Republic with a north-western direction. Vector 2 a wide Pacific Ocean wind current intercepted Vector 1 and deflected it see page 9 of 10. The interception caused a gradual deflection of Irene yielding towards the north. Vector 2 combined with a North America wind continued swaying the resultant vectors until succeeding in total control of the hurricane, in the vicinity of South Carolina, establishing a north/north-eastern routing, crossing over cape Hatteras to finally hit the area of New Jersey.

C-2) Case 3: Hurricane Irene could have been swayed away in year 2011. Page 10 of 10 shows an early point A where we could have applied our north-eastern pushing swaying vectors. Our vectors would have succeeded deflecting the hurricane Irene into a pre-selected destination area located north of Dominican Republic well inside the North Atlantic Ocean.

### D) Symbols and Nomenclature:

A—Point of action and impact of our swaying vectors. Also America's wind vector 4.

B—Second point of action, if needed to finish the job.

D—Pre-selected calm area destination

SW-SV—South Western Swaying Vectors

RV—Resultant Vector

1—Original path of carrying wind current driving the Hurricane.

2, 3, 4—Intercepting Wind Currents, as shown

2′, 3′, 4′—Opposite sides of parallelogram, as shown

2″—Vector 2″ continues direction of vector 2

→—Arrow vectors

### DETAILED DESCRIPTION OF THE INVENTION

Hurricanes are usually formed over the ocean as described in (f). If the storms are stagnant they will consume all the surplus energy of the area of birth and stop right there. Hurricanes that are steered by wind currents, of moderate speed, go absorbing large amounts of energy as they progress. (See Ref. 2) The thermodynamic of the storm, storage the newly absorbed energy by growing in size and by increasing its rotating speed. The centrifugal and centripetal forces play a very active role by keeping together the system and causing the cylindrical form. At the same time that the storm grows in size, the initial speed of travelling of the steering wind, gets slower proportionally to the growth of weight and size of the storm. Consequently, favor the absorption of energy of the storm. When going over land the absorption process slows down because there is lesser amount of transferable energy available to absorb. At the same time the storm discharges energy in the form of rain and gusts. This behavior is due to the active function of the thermodynamic of the storm, always seeking to stabilize the system to reach the state of equilibrium. My Method to influence the direction of travel of hurricanes, from here on called, in these specifications, as the Method, takes advantage of the fact that hurricanes does not have, thanks God, forward motion of their own. Also, my Method, reproduce the same actions that wind currents do to each other, when intercepting freely, in space. (See Ref. 1) My Method does pretend neither to destroy nor to reduce the intensity of the hurricanes. My Method takes advantage also of the fact that the storm rotates fast in a counterclockwise way. Also, that to travel, the storm requires the thrusting vector force of a steering wind pushing at its back, thus creating a thrusting area well immersed inside the storage area of the storm.

My Method pretends to deflect the direction of travel of the hurricanes by way of throwing successive expansive waves of hot gas explosions; blasting inside the thrusting area of the steering wind at the back of the hurricane. These impacts must be aligned as precisely, as possible, in one selected direction to cut in the shortest possible direction thru the range width of the steering wind with the minimum amount of explosions. The spacing between the successive explosions inside the thrusting area must be, as close and frequent as, the availability of the launching equipment permits to use. Thus, the explosions of the next following will join and back up together with the preceding ones due to the effect of ‘holding-back’ of the impact reaction of the explosions against the current force of the steering wind. The resultant vector of the interception of the explosive vector with the steering wind vector, called R1 on the drawing of my method, will simultaneously combine with the counterclockwise vector. The resultant of the combination of the counterclockwise vector with the resultant R1, produce the resultant called R2. The counterclockwise vectors power shall reinforce greatly the initial force of the swaying vectors and speed up the process. But not just one, action line only, will be enough to overcome the initial inertia, of the entire mass of the storm. To succeed we need to act simultaneously with, as many levels of action as possible. We can divide the entire height of the steering wind by twice the diameter length of the typical explosion, to find “N” number of levels of action. Then, provided we have available all the required missiles and launching equipment that we need, we can engage in action. But first an actual live research is necessary to answer all the questions of what kind of explosive is required, maybe solid form or storable liquid propellant 300 pounds missile, will work. Depending on, when tested in actual live research if the explosion will not be too strong or too fast, that instead of providing us with the thrusting power we need, what we will get is a hole in the clouds.

Our live research task is to find not only the kind of explosive that will push on winds without going thru them, but to find the optimum amount of explosive that will reduce the total number of blasting. Also, to find the proper missile launching equipment that combined with the lesser amount of units we can get us only the missiles we need, at all levels. That means trying other type of launching equipment and different type of missiles.

To overcome a lesser inertia of the Storm we can act better against early stages of the storms to start swaying sooner and succeed at a lesser cost. We shall be able to accomplish the task with a lesser number of air-vehicles with a launching capacity of only two missiles each or less.

In my opinion the early action against storms that may become a threat to islands and continental land that happen in areas of the Caribbean Sea that historically have caused, dangerous hurricanes, is enough justification to act.

Detailed instructions for implementation of the Method: a live testing of the method should be part of the Federal Sponsored Research and Development. These instructions assume that, if that research happens, we will have a crew of professionals on explosives, missile launchers, and all the proper military facilities and the authorization of the US Government to proceed with the test. Assuming that is the case, I will provide the Plan of Action and instructions, as follows:

Plan of action: The corresponding governmental offices of meteorology will provide us with the location data and all characteristic information relating to the storm. Also the steering wind data of routing, speed, height and range width of the steering wind at the thrusting area within the hurricane. Also, the Meteorology Office shall provide the location of the impact area between the steering wind current and the back of the Storm. Say, for instance that the steering wind is 12,000 feet high and 8,000 feet wide and the initial explosion diameter of the blast is five hundred feet, hence we need 12,000/(500×2)=12 levels. We have a 2,000 feet of no blasting self-imposed limitation, which is the first lower level and we can neglect blasting at the upper level hence we have remaining 12−2=10 levels of action. Considering the small size of the storm we can use 200 pounds missiles and skip every other level and act on five levels, only. These expansive waves of gases to thrust properly should explode in good alignment, at the assigned level, inside the thrusting area of the steering wind and the outer edge of the storm. Each Air-Vehicle should be assigned an action level in order, for instance number one plane to act on level 11, number 2 on level 9, number 3 on level 7, number 4 on level 5 and number 5 on level 3.

The entire three squadrons of twelve air-vehicles each should be stationed at exclusive, well guard, under cover and securely enclosed hangars. We need to be on American island land close to the coming storm ready to act as soon as authorized to proceed. The crews should be trained and rehearsed in simulated shooting exercises and the Navigational Engineer practicing his role of providing the target coordinates adjusted for each of the planes considering the moving target and differences in height and speed for each of the planes.

Each plane should strike say every 5 seconds and in all strike 6 missiles for a total of 6 times 5=30 missiles of 200 pounds each, equal to 6,000 pounds or otherwise as planned when we get more information and more training we shall be able to refine our calculations and save on the total amount of explosives. We may be able to start with 300 pounds missiles to overcome the initial inertia and finish up with the 200 pounds. Depending on the capacity of each air-vehicle to launch missiles, two, three or six we need to use three, two or just one plane for each round of explosives.

We will give the coordinates to strike precisely to each of the pilots, or UAV as provided by an Airplane Navigating Engineer, that will be flying over the target area at a prudent distance, also keeping a photographic record of the entire operation specially at the moment of action and immediately after to check if we succeeded and how much we achieved on swaying the storm out of it route.

Pause and Evaluation: After launching the first 30 missiles we will pause to evaluate the results of the impacts, on the satellite monitor of the action. Check how much displacement of the storm we got, if any, and verify if the missiles exploded correctly inside the thrusting area, or how far away they were, to make the necessary corrections and adjustments to try again. We may decide to continue with a second round of missiles if we have the availability to do so. Also, the Management may decide to continue, if we receive encouraging early results in our monitors.

If we succeed to overcome the initial inertia of the storm to get moving towards the outside of the range of the steering wind, from that moment on, the new developed inertia of the storm will become our ally. END.

1. I claim My Method to Influence the Direction of Travel of Hurricanes, and to sway them into a desired direction, as here in described in these specifications, for intersecting, thrusting and deflecting the routing of storms and hurricanes by way of detonating and blasting, simultaneous and cumulative explosions of non-nuclear solid or storable liquid propellant fuel that shall produce thrusting expansive waves of hot gases, thrown perpendicular to the routing of the steering wind current and into the inside area of thrusting between the steering wind and the inside of the outer edge of the hurricane at pre-determined horizontal levels, found by dividing the total height of the steering wind by N number of spaces, each space to be no more than twice the diameter of the blast explosion, this process shall be continued and repeated, as many times as necessary to accumulate the action of the blasting waves, spaced approximately twice the length of its own diameter inside the thrusting area, until overcoming the initial inertia of the storm and start moving the hurricane or storm towards the outer edge of the range of the steering wind and thus progressing gradually and continuously, succeed in swaying away the storms or hurricanes from their original routing and into a new direction, where it may be pushed to by thrusting at the outer edge, behind the storm with blasts of expansive gasses lighter in density than the density of the mixture matter of the hurricane, at a lesser number of strikes and for as long as necessary in the selected direction.
